(19) United States
(12) Patent Application Publication
(10) Pub. No.: US 2024/0337474 A1
(43) Pub. Date: Oct. 10, 2024

(54) MEASURING DEVICE AND ABSOLUTE ANGLE IDENTIFICATION METHOD

(71) Applicant: MITUTOYO CORPORATION, Kawasaki (JP)

(72) Inventors: Shunsuke Tanaka, Kanagawa (JP); Hirokazu Kobayashi, Saitama (JP)

(21) Appl. No.: 18/624,666

(22) Filed: Apr. 2, 2024

(30) Foreign Application Priority Data
Apr. 6, 2023 (JP) 2023-062276

(51) Int. Cl. G01B 5/24; G01B 3/00; G01B 11/26

(52) U.S. Cl. CPC G01B 5/24; G01B 3/004; G01B 11/26

(57) ABSTRACT

A measuring device includes a first scale provided on a rotary scale, arranged around an rotation axis of the rotary scale, and having first patterns arranged along a circumferential direction, a second scale provided on the rotary scale, arranged around the rotation axis, and having a plurality of second patterns arranged along the circumferential direction, first pattern detection sections arranged around the rotation axis, a second detection section that faces the second scale and reads at least a part of the plurality of second patterns, and a calculator configured to identify an absolute angle of the rotary scale, on a basis of a reading result of the first pattern detection sections and a reading result of the second pattern detection section. A number of the second pattern detection section is less than a number of the plurality of first pattern detection sections.

### CROSS-REFERENCE TO RELATED APPLICATION

This application is based upon and claims the benefit of priority of the prior Japanese Patent Application No. 2023-062276 filed on Apr. 6, 2023, the entire contents of which are incorporated herein by reference.

### FIELD

A certain aspect of embodiments described herein relates to a measuring device and an absolute angle identification method.

### BACKGROUND

Conventionally, measuring devices that can detect a rotation angle around a specific axis or a rotation speed are known. Such measuring devices are equipped with a rotary encoder. The rotary encoder is a position sensor that converts the amount of mechanical displacement in the rotational direction of an object to be measured into a digital amount. The rotary encoder includes a scale in which a plurality of patterns are arranged in the circumferential direction, and a detection section (detection head) disposed opposite to the scale.

By the way, since it is convenient to immediately know the current angle (absolute angle) of the object to be measured, an absolute type absolute position measuring device that makes this possible is known (for example, Japanese Patent Application Publication No. 2007-304052 herein after referred to as Patent Document 1). The absolute position measuring device in Patent Document 1 includes a phase signal transmitting means for transmitting two phase signals having mutually different periods according to the rotation of the spindle in order to measure the position of the spindle in an absolute manner. Here, the phase signal transmitting means includes a first rotary encoder and a second rotary encoder. In addition, in order to improve the measurement accuracy of rotary encoders, a method has been proposed in which multiple detectors are arranged on the circumference and the data obtained from each detector is averaged (for example, in the International Publication No. 2019/039344 hereinafter referred to as Patent Document 2 or Japanese Patent Application Publication No. 2001-12967 hereinafter referred to as Patent Document 3).

### SUMMARY

In one aspect, the present invention aims to reduce the number of components of a measuring device and reduce current consumption of the measuring device.

According to an aspect of the present invention, there is provided a measuring device including: a first scale that is provided on a rotary scale, is arranged around an rotation axis of the rotary scale, and has a plurality of first patterns arranged along a circumferential direction of the rotary scale; a second scale that is provided on the rotary scale, is arranged around the rotation axis, has a plurality of second patterns arranged along the circumferential direction and located at different positions from the first scale; a plurality of first pattern detection sections that are arranged around the rotation axis, each of which faces the first scales and reads at least a part of the plurality of first patterns; a second detection section that faces the second scale and reads at least a part of the plurality of second patterns; and a calculator configured to identify an absolute angle of the rotary scale, on a basis of a reading result of the plurality of first pattern detection sections and a reading result of the second pattern detection section, wherein a number of the second pattern detection section is less than a number of the plurality of first pattern detection sections.

According to another aspect of the present invention, there is provided an absolute angle identification method for identifying the absolute angle in the measuring device, the method comprising: reading the plurality of first patterns by using the plurality of first pattern detection sections; reading the plurality of second patterns by using the second pattern detection section; and calculating an absolute angle of the rotary scale on a basis of a reading result of the plurality of first pattern detection sections and a reading result of the second pattern detection section.

### BRIEF DESCRIPTION OF DRAWINGS

FIG. 1A and FIG. 1B are block diagrams schematically illustrating a configuration of a measuring device according to a first embodiment;

FIG. 2 is a diagram illustrating an arrangement of a first scale and a second scale included in a measuring device of a first embodiment;

FIG. 3 illustrates a first outer detection head to a fourth outer detection head, each corresponding to a first pattern detection section included in a measuring device of a first embodiment, and a first inner detection head and a second inner detection head, each corresponding to a second pattern detection section;

FIG. 4 illustrates details of a first detection head in a first embodiment;

FIG. 5 illustrates a relationship between an absolute angle of a rotary scale and a signal phase of a detection head of a measuring device of a first embodiment;

FIG. 6 is a graph illustrating a relationship between a difference between an outer circumference detection head signal phase (θ5) and an inner circumference detection head signal phase (θ7), and an absolute angle of a rotary scale in a measuring device of a first embodiment;

FIG. 7 is a cross-sectional view schematically illustrating a state in which a substrate on which a detection head is provided and a rotary scale are tilted relative to each other around an X-axis;

FIG. 8A and FIG. 8B are diagrams illustrating an example of a circuit configuration for setting gain;

FIG. 9 is a graph illustrating a relationship between a distance between a detection head and a rotary scale, and a signal strength;

FIG. 10 is a graph illustrating a relationship between a distance between a detection head and a rotary scale, and a signal strength for each gain;

FIG. 11 is a graph illustrating a signal strength when a gain is set to “gain 1” for each detection head;

FIG. 12 is a graph illustrating s gain with which appropriate signal strength can be obtained for a first detection head and a third detection head;

FIG. 13 is a graph illustrating a gain with which an appropriate signal strength can be obtained for s fourth detection head;

FIG. 14A and FIG. 14B are block diagrams schematically illustrating a configuration of a measuring device according to a second embodiment;

FIG. 15A and FIG. 15B are block diagrams schematically showing a configuration of a measuring device according to a third embodiment;

FIG. 16 is an example of a time chart showing sampling timing in a fourth embodiment; and

FIG. 17 is an example of a time chart showing sampling timing in a fifth embodiment.

### DESCRIPTION OF EMBODIMENTS

As disclosed in Patent Document 1, by providing many detection units, it becomes possible to detect the absolute angle with high accuracy.

However, as the number of detection units increases, the number of components of the measuring device increases, and the current consumption of the measuring device also increases.

Hereinafter, embodiments will be described with reference to the drawings.

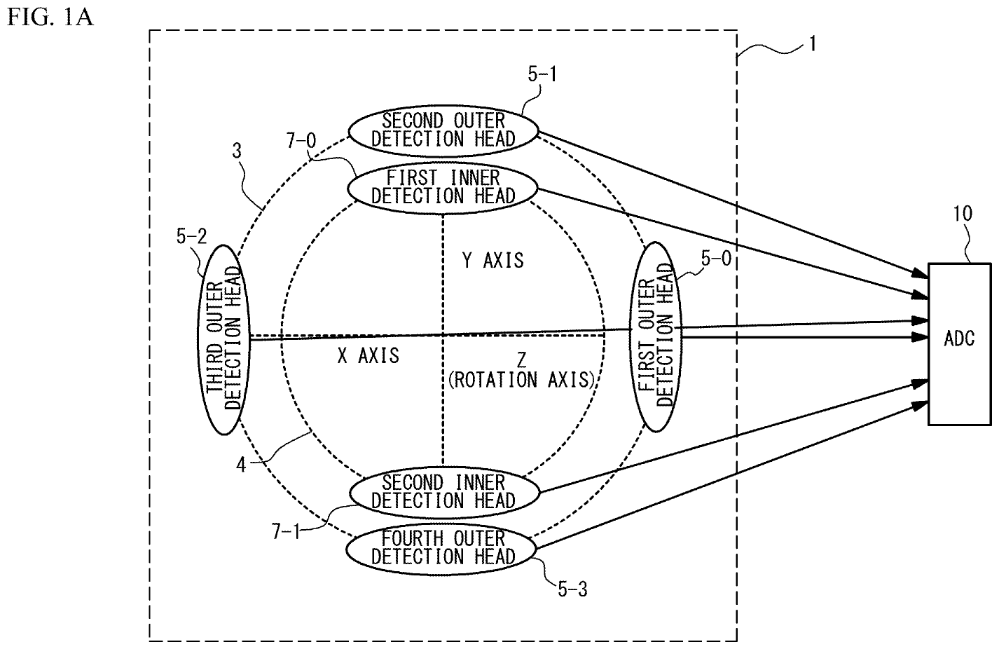

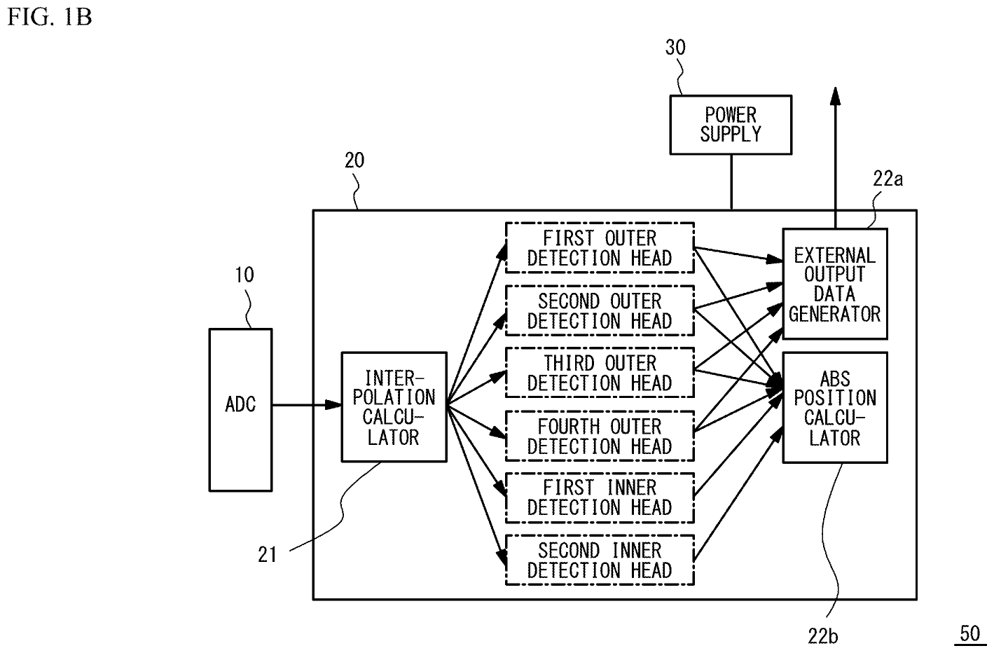

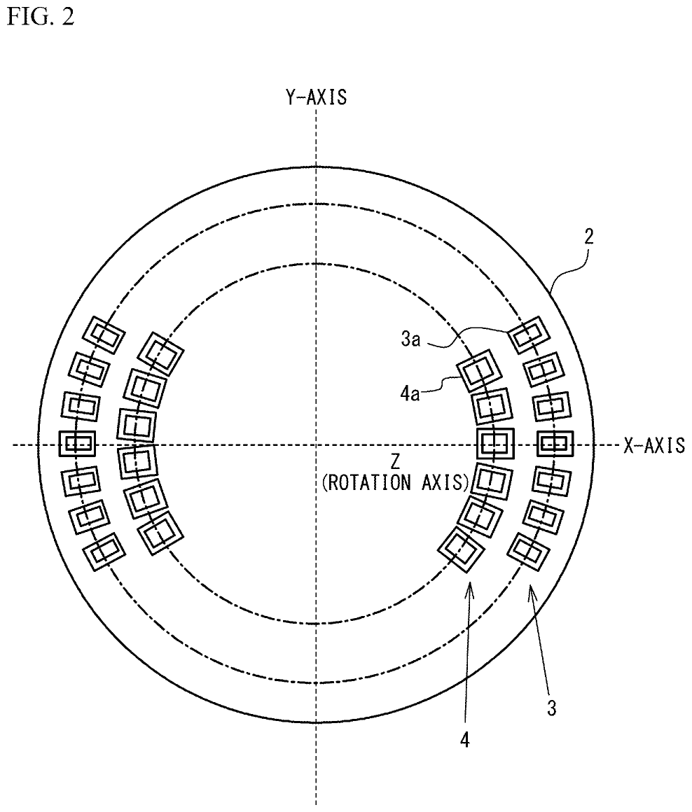

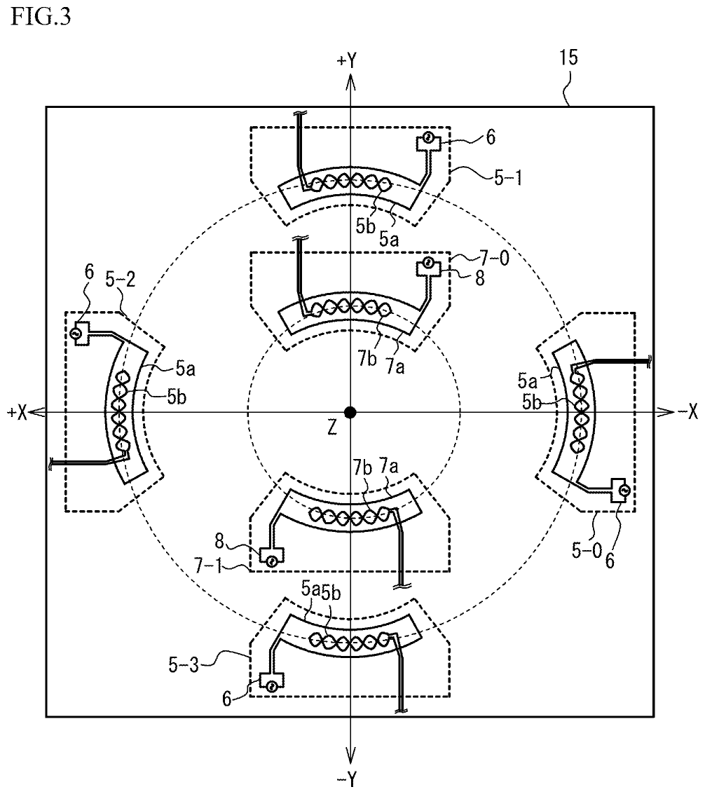

(First embodiment) A schematic configuration of a measuring device 50 of the first embodiment will be described with reference to FIG. 1A to FIG. 3. FIG. 1A and FIG. 1B is a block diagram schematically illustrating the configuration of the measuring device 50 according to the first embodiment. FIG. 2 is a diagram illustrating the arrangement of a first scale 3 and a second scale 4 included in the measuring device 50 of the first embodiment. FIG. 3 illustrates a first outer detection head 5-0 to a fourth outer detection head 5-3, each corresponding to a first pattern detection section included in the measuring device 50 of the first embodiment, and a first inner detection head 7-0 and a second inner detection head 7-1, each corresponding to a second pattern detection section.

The measuring device 50 can measure the rotation angle and rotation speed of a rotating body (not illustrated) to be measured.

Referring to FIG. 1A and FIG. 1B, the measuring device 50 includes a rotary encoder 1 and a calculator 20. An electrical power supply 30 is connected to the calculator 20. The calculator 20 receives electrical power from the electrical power source 30 and performs measurement using the rotary encoder 1. Electrical power is also supplied to the rotary encoder 1 via the calculator 20. Note that the rotary encoder 1 is of an absolute type in which a plurality of scales are arranged on the circumference so that the current angle (absolute angle) can be specified.

<Rotary encoder> The rotary encoder 1 includes a rotary scale 2 and four detection heads each corresponding to a first pattern detection section, specifically, the first outer detection head 5-0 to the fourth outer detection head 5-3. Further, the rotary encoder 1 includes two detection heads each corresponding to a second pattern detection section, specifically, the inner first detection head 7-0 and the inner second detection head 7-1. Both the first pattern detection section and the second pattern detection section can be provided in n pieces (n is an integer of 2 or more), but the number of the second pattern detection sections is less than the number of the first pattern detection sections. Here, in order to achieve high accuracy as a rotary encoder, the number of the first pattern detection sections on the outer circumference side with a longer circumference is larger, and the number of the second pattern detection sections on the inner circumference side that is used only for detecting the absolute is smaller. As will be explained later, the rotary scale 2 is provided with the first scale 3 and the second scale 4. The first outer detection head 5-0 to the fourth outer detection head 5-3 are arranged to face the first scale 3. On the other hand, the first inner detection head 7-0 and the second inner detection head 7-1 are arranged to face the second scale 4.

The first outer detection head 5-0 to the fourth outer detection head 5-3 are arranged on a circle around the Z-axis, which is the center of rotation of the rotary scale 2, as the center axis. Referring to FIG. 3, the four detection heads are installed at intervals of 90 degrees in the counterclockwise direction, with the position where the first outer detection head 5-0 is provided as a reference position (0 degrees). The first outer detection head 5-0 to the fourth outer detection head 5-3 are each provided with a transmitting coil 5a and a receiving coil 5b.

The transmitting coil 5a constitutes a fan-shaped coil whose length is in the circumferential direction. Inside the transmitting coil 5a, the receiving coil 5b forms a detection loop that is repeated in the circumferential direction at a basic period λ using a positive and negative sinusoidal waveform pattern having a basic period λ.

The first inner detection head 7-0 and the second inner detection head 7-1 are arranged around the Z-axis, which is the center of rotation of the rotary scale 2, as the center axis. Referring to FIG. 3, the inner first detection head 7-0 is arranged at a position separated by 90° counterclockwise from the reference position (0°) where the outer first detection head 5-0 is provided. Further, the inner second detection head 7-1 is arranged at a position separated by 270° in a counterclockwise direction from the reference position (0°) from the position where the outer first detection head 5-0 is provided. The first inner detection head 7-0 and the second inner detection head 7-1 are arranged at positions separated by 180 degrees, and are opposed to each other.

As a result, the circumferential position of the inner first detection head 7-0 coincides with the circumferential position of the outer second detection head 5-1. That is, the first inner detection head 7-0 and the second outer detection head 5-1 are both arranged at a position of 90 degrees counterclockwise from the reference position (0 degrees). Further, the circumferential position of the inner second detection head 7-1 coincides with the circumferential position of the outer fourth detection head 5-3. That is, both the inner second detection head 7-1 and the outer fourth detection head 5-3 are arranged at a position of 270° counterclockwise from the reference position (0°).

The first inner detection head 7-0 and the second inner detection head 7-1 are located in a circle inside the circle in which the first outer detection head 5-0 to the fourth outer detection head 5-3 are arranged. The first inner detection head 7-0 and the second inner detection head 7-1 are provided with a transmitting coil 7a and a receiving coil 7b, respectively.

The transmitting coil 7a constitutes a fan-shaped coil whose length direction is in the circumferential direction. Inside the transmitting coil 7a, the receiving coil 7b forms a detection loop that is repeated in the circumferential direction at a basic period \′ by a positive and negative sinusoidal waveform pattern having a basic period A′. The basic period A′ is different from the basic period λ in the transmitting coil 5a. Note that the first pattern detection section and the second pattern detection section only need to be located at different positions, and the detection head group corresponding to the first pattern detection section may be arranged inside, and the detection head group corresponding to the second pattern detection section may be arranged outside.

As illustrated in FIG. 2, the rotary scale 2 is a disc-shaped member, and is attached to a rotating body (not illustrated) to be measured, with its rotation axis and center of rotation (Z-axis) aligned. The rotary scale 2 includes the first scale 3 and the second scale 4.

The first scale 3 includes a plurality of patterns 3a arranged at a fundamental period λ along the circumferential direction of the rotary scale 2. The pattern 3a is a closed loop coil. The pattern 3a corresponds to the first pattern, and the circle in which the plurality of patterns 3a are arranged corresponds to the circle in which the first outer detection head 5-0 to the fourth outer detection head 5-3 are arranged. As a result, the first outer detection head 5-0 to the fourth outer detection head 5-3 are in a state facing the first scale 3. Each of the patterns 3a is electromagnetically coupled to the transmitting coil 5a and also electromagnetically coupled to the receiving coil 5b.

A transmitting circuit 6 is connected to each of the transmitting coils 5a. The transmitting circuit 6 generates a single-phase AC drive signal and supplies the signal to the transmitting coil 5a. In this case, magnetic flux is generated in the transmitting coil 5a. As a result, electromotive currents are generated in the plurality of patterns 3a. The plurality of patterns 3a generate magnetic flux that changes at a predetermined spatial period in the circumferential direction by electromagnetically coupling with the magnetic flux generated by the transmitting coil 5a. The magnetic flux generated by the transmitting coil 5a causes an electromotive current to be generated in the receiving coil 5b. The electromagnetic coupling between each coil changes according to the amount of displacement amount of the rotary scale 2, and a sine wave signal having the same period as the fundamental period λ is obtained.

The receiving coil 5b is formed, for example, into a flat member. The flat member is, for example, a substrate 15. Each of the receiving coils 5b has a section for switching between positive and negative sine waveform patterns. Therefore, the receiving coil 5b has a thickness not only on the surface of the flat member. The receiving coil 5b can also be formed on a printed wiring board. In this case, the sinusoidal waveform patterns are placed with an insulator therebetween, and a through hole is placed in the switching section to electrically connect the two sinusoidal waveform patterns. Each of the receiving coils 5b is connected to the calculator 20, and the signal input from each of the receiving coils 5b to the calculator 20 is used for measurement in the measuring device 50 and for specifying the absolute angle at that time. Although each of the receiving coils 5b and the calculator 20 are connected by wire, they may be connected wirelessly.

In this embodiment, each detection head is equipped with the transmitting coil 5a, but for example, one transmitting coil may be provided independently, and a signal transmitted from this transmitting coil toward the rotary scale 2 can be transmitted to each of the receiving coils 5b.

The second scale 4 includes a plurality of patterns 4a arranged along the circumferential direction of the rotary scale 2 at a fundamental period \′. The pattern 4a is a closed loop coil. The pattern 4a corresponds to the second pattern, and the circle on which the plurality of patterns 4a are arranged corresponds to the circle on which the inner first detection head 7-0 and the inner second detection head 7-1 are arranged. As a result, the first inner detection head 7-0 and the second inner detection head 7-1 are in a state facing the second scale. Each of the patterns 4a is electromagnetically coupled to the transmitting coil 7a and also electromagnetically coupled to the receiving coil 7b.

A transmitting circuit 8 is connected to each of the transmitting coils 7a. The connection relationship between the transmitting circuit 8 and the transmitting coil 7a is the same as the connection relationship between the transmitting circuit 6 and the transmitting coil 5a. Further, like the receiving coil 5b, the receiving coil 7b is formed, for example, into a flat member. Therefore, detailed explanations regarding these will be omitted. By providing the transmitting coil 7a, the receiving coil 7b, and the transmitting circuit 8, the electromagnetic coupling between the coils changes according to the amount of displacement of the rotary scale 2, and a sine wave signal having the same period as the fundamental period A′ can be obtained. The transmitting coil 7a and the receiving coil 7b can adopt the same modification as the transmitting coil 5a and the receiving coil 5b.

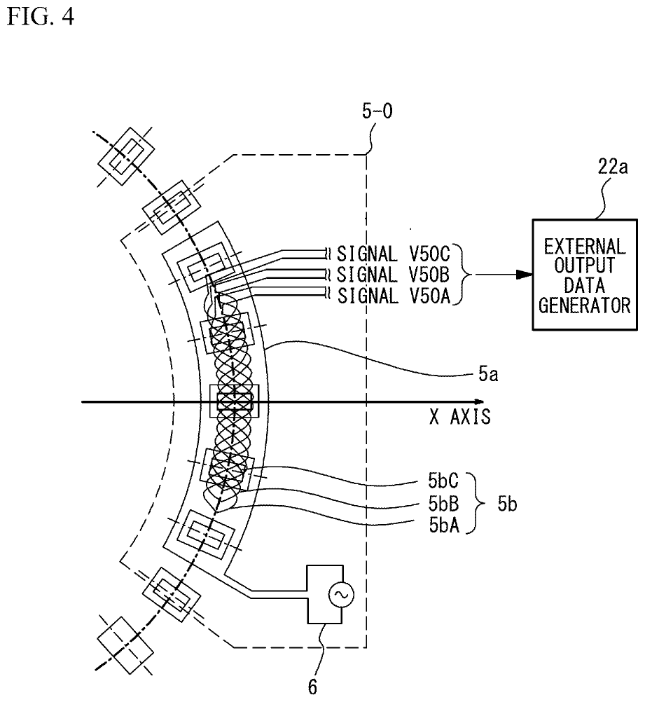

In FIG. 3, for clarity of illustration, each one detection loop with a positive and negative sinusoidal waveform pattern with a fundamental period 2 is illustrated inside the transmitting coil 5a and the transmitting coil 7a as the receiving coil 5b and the receiving coil 7b. FIG. 4 illustrates this detection loop in more detail. As illustrated in FIG. 4, the receiving coil 5b includes three sets of receiving coils 5bA, 5bB, and 5bC arranged with their spatial phases shifted by 120 degrees along the length measurement direction. Then, signals V50A, V50B, and V50C each having a 120° phase difference in the length measurement direction are output.

In the rotary encoder 1 of this embodiment, the rotary scale 2 is mounted on the rotating body side which is the object to be measured. The first outer detection head 5-0 to the fourth outer detection head 5-3, the first inner detection head 7-0, and the second inner detection head 7-1 may be set on the rotating body side. In short, the rotary encoder 1 only needs to be placed in a state where the rotary scale 2 and each detection head face each other in the object to be measured.

Although the rotary encoder 1 of this embodiment is of an electromagnetic induction type, the rotary encoder 1 may also be of a form using other detection principles such as an electrostatic capacitance type or a photoelectric type. In the case of using a rotary encoder of another type, a transmitting section and a receiving section corresponding to the format adopted by the rotary encoder are used as the transmitting coil and the receiving coil, respectively.

Note that the distance between each detection head, the dimensions of each detection head, and the dimensions of the rotary scale 2 in each figure are not accurately represented. Further, the dimensions of the first pattern 3a and the second pattern 4a and the distance between each pattern in each figure are not accurately represented.

As described above, the first scale 3 includes the plurality of patterns 3a arranged at a fundamental period λ along the circumferential direction of the rotary scale 2. Further, the second scale 4 includes the plurality of patterns 4a arranged at a fundamental period A′ along the circumferential direction of the rotary scale 2. The number of patterns 3a on the first scale 3 and the number of patterns 4a on the second scale 4 are different from each other. In this way, by making the number of patterns 3a and the number of patterns 4a different, it becomes possible to calculate the absolute angle.

<Calculator> The calculator includes an interpolation calculator 21, an external output data generator 22a, and an absolute angle calculator (hereinafter referred to as “ABS position calculator”) 22b. Signals read by each detection head are input to the interpolation calculator 21 via an ADC (analog/digital conversion unit) 10. The interpolation calculator 21 obtains the phase angle θ50 by performing the following arithmetic processing on the signals V50A, V50B, and V50C from the receiving coils 5bA, 5bB, and 5bC of the first outer detection head 5-0, for example.

$$X = ( 1 / 3 ) \times ( 2 \times V 50 A - V 50 B + V 50 C ) \qquad ( Formula 1 )$$

$$Y 1 = ( 1 / √ 3 ) \times ( V 50 C - V 50 B ) \qquad ( Formula 2 )$$

$$θ50 = {tan}^{- 1} ( Y 1 / X 1 ) \qquad ( Formula 3 )$$

Similarly, the phase outputs θ51 to θ53 in the second outer detection head 5-1 to the fourth outer detection head 5-3, and the phase outputs θ70 and θ71 in the first inner detection head 7-0 and the second inner detection head 7-1 are calculated.

The phase output obtained for each detection head is used to calculate the absolute angle by the ABS position calculator 22b. In this embodiment, the absolute angle is calculated using the phase outputs obtained from each of the four outer circumference detection heads and the two inner circumference detection heads. First, the signal phase θ5 of the outer circumference detection head is determined by averaging the phase outputs (θ50 to θ53) obtained from the four outer circumference detection heads. Further, by averaging the phase outputs (θ70, θ71) obtained from the two inner circumference detection heads, the signal phase θ7 of the inner circumference detection head is determined.

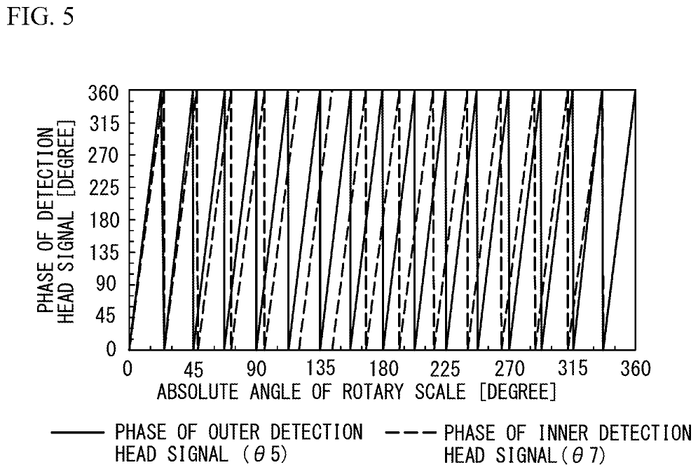

Next, absolute angle calculation using the fact that the number of the patterns 3a of the first scale 3 detected by the outer circumference detection head and the number of the patterns 4a of the second scale 4 detected by the inner circumference detection head are different will be explained. FIG. 5 illustrates the relationship between the signal phase θ5 of the outer detection head and the signal phase θ7 of the inner detection head when the number of the patterns 3a of the first scale 3 is 16 and the number of the patterns 4a of the second scale 4 is 15.

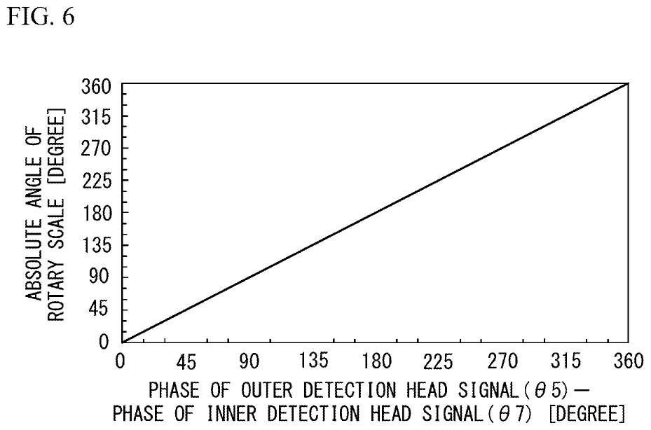

Although 05 and 07 increase according to the rotation angle of the rotary scale 2, the slopes are different because the number of patterns is different. Therefore, as illustrated in FIG. 6, by determining the difference between 05 and 07, the rotation angle within one rotation of the rotary scale 2, that is, the absolute angle can be determined.

Here, the two inner circumference detection heads are used only for calculating the absolute angle. If we prepare the same number of inner detection heads as outer detection heads and tried to detect the absolute angle using all of these detection heads, the number of components of the measuring device 50 would increase accordingly, and the current consumption would also increase. According to this embodiment, the number of inner circumference detection heads used only for detecting the absolute angle is smaller than the number of outer circumference detection heads. Thereby, the number of components of the measuring device 50 can be reduced, and the current consumption of the measuring device can be reduced.

In this embodiment, the first outer detection head 5-0 to the fourth outer detection head 5-3 are rotated every 90° counterclockwise from the reference position (0°) where the first outer detection head 5-0 is provided. Further, the circumferential position of the inner first detection head 7-0 coincides with the circumferential position of the outer second detection head 5-1. The circumferential position of the inner second detection head 7-1 coincides with the circumferential position of the outer fourth detection head 5-3. The angular output obtained by each detection head may contain errors. By arranging each detection head as described above, the angular output obtained by the outer detection head placed at the same angle from the reference position and the errors included in each output obtained by the inner detection head may be close values. Therefore, when calculating the absolute angle, error components can be easily canceled out, and calculation accuracy can be improved.

Note that since the calculation of this absolute angle involves the signal phase θ7 detected by the inner circumference detection head, the accuracy of detecting of the absolute angle is inferior to the detection accuracy of the signal phase θ5 detected only by the outer circumference detection head. Therefore, after calculating the absolute angle, the measuring device 50 generates external output data in which the absolute angle is combined with the signal phase θ5 detected only by the outer circumference detection head in the external output data generator 22a. That is, the rotation angle or the rotation speed of the object to be measured is detected based on the angle output obtained by the four outer circumference detection heads, that is, the first outer circumference detection head 5-0 to the fourth outer circumference detection head 5-3. In this case, the measurement accuracy of the measuring device 50 can be improved by using the four detection heads.

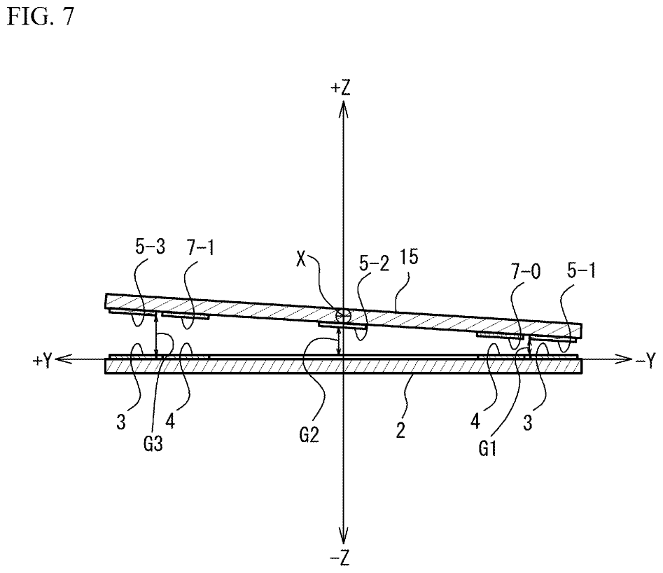

The rotary scale 2 and the flat member on which each detection head is formed, and in this embodiment, the substrate 15, are arranged facing each other as described above. The rotary scale 2 and the flat member are assembled so that a predetermined gap is formed therebetween. The rotary scale 2 and the flat member may be assembled in a relatively inclined state depending on the accuracy of assembly and various conditions of the object to be assembled. In this case, the gap between the two differs depending on the position in the circumferential direction. For example, as illustrated in FIG. 7, assume that the substrate 15 and the rotary scale 2 are tilted relative to each other around the X axis. In this case, when observing the substrate 15 and the rotary scale 2 from the −X side, the gap between the outer second detection head 5-1 and the first scale 3 is G1. The gap between the outer third detection head 5-2 and the first scale 3 is G2. The gap between the fourth outer detection head 5-3 and the first scale 3 is G3. The size relationship of each gap is G1<G2<G3. In this embodiment, the gap between the first outer detection head 5-0, which is disposed facing the third outer detection head 5-2 along the X-axis, and the first scale 3 is also G2.

Therefore, in this embodiment, the gain is set for each detection head according to the size of such a gap. In other words, the gain of the second outer detection head 5-1 is set according to the gap G1. The gains of the first outer detection head 5-0 and the third outer detection head 5-2 are set in accordance with the gap G2. Regarding the outer circumferential fourth detection head 5-3, the gain is set according to the gap G3. Thereby, more accurate detection results can be obtained. Note that the aspect illustrated in FIG. 7 indicates one aspect of the relative inclination between the substrate 15 and the rotary scale 2, and the gain setting is determined based on the gap size for each detection head according to the actual inclination.

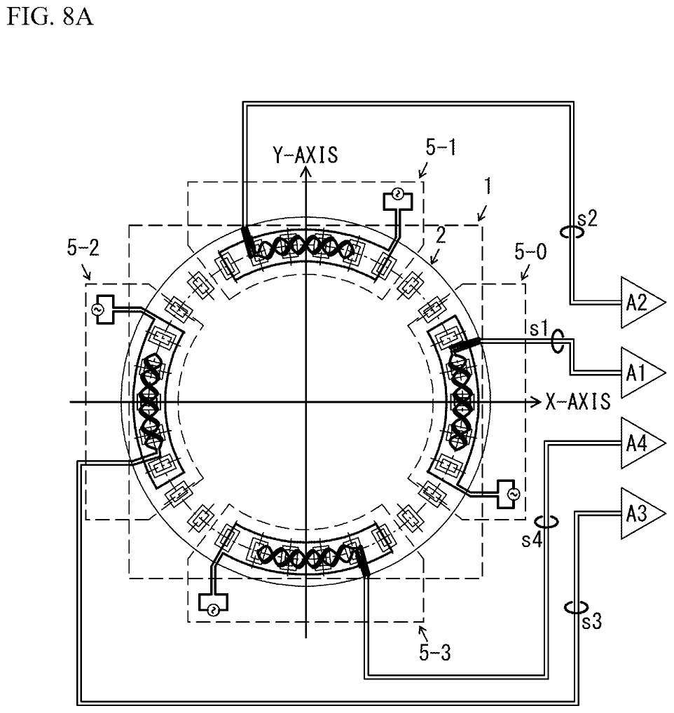

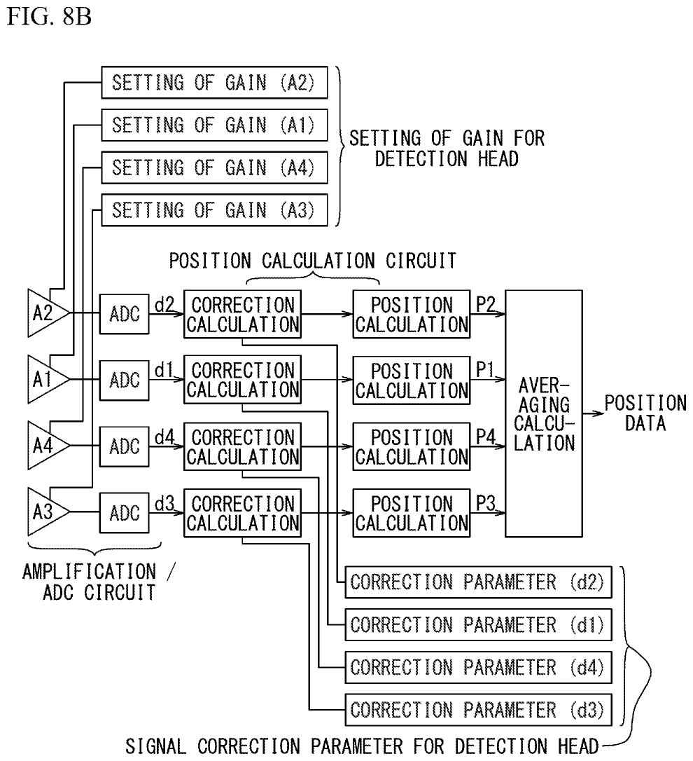

A specific example of gain setting will be described below. The signal strength of the signal output from each detection head (the first detection head 5-0 to the fourth detection head 5-3) is measured by an ADC provided for each detection head, as illustrated in FIG. 8A and FIG. 8B.

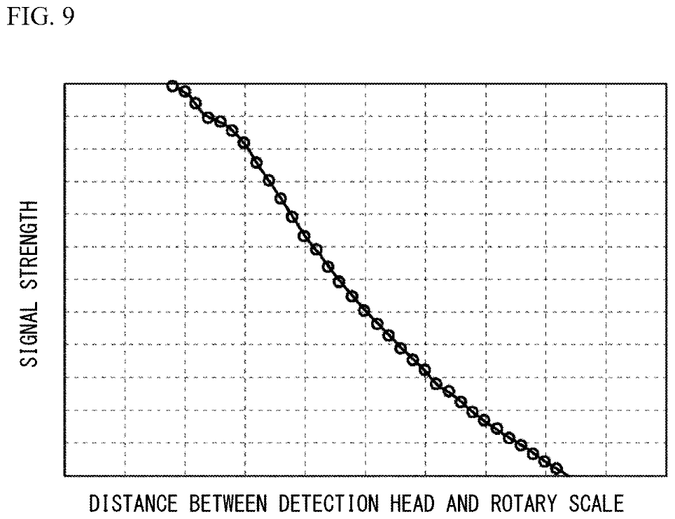

As illustrated in FIG. 9, the gap, that is, the distance between each detection head and the rotary scale 2, and the signal strength have a relationship in which the signal strength decreases as the distance increases. Therefore, by measuring the signal strength, the gap can be derived.

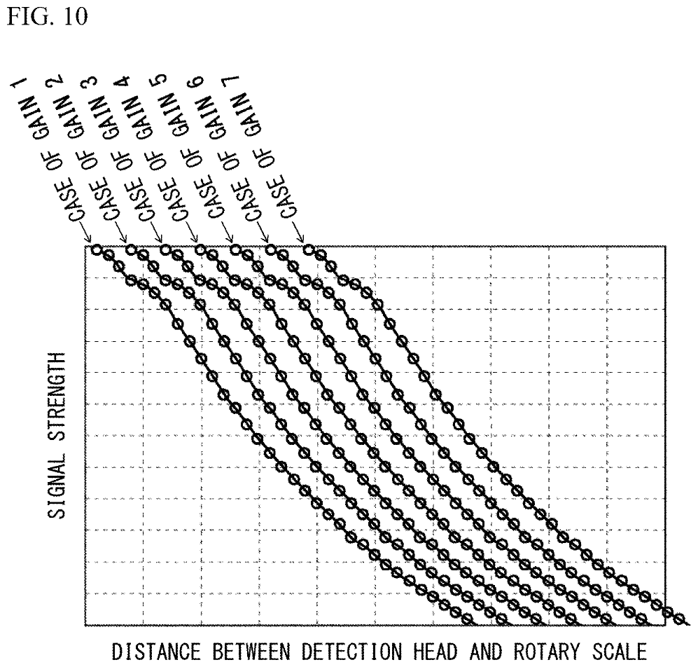

As illustrated in FIG. 10, even if the signals arriving from the detection head are the same, if the gains of the amplifier circuits (A1 to A4) differ, the signal strength measured by the ADC changes. Note that the numerical values in Gain 1 to Gain 7 indicate the magnitude of the gain. Gain 1 is the smallest. The gain increases as the number increases. And Gain 7 is the largest.

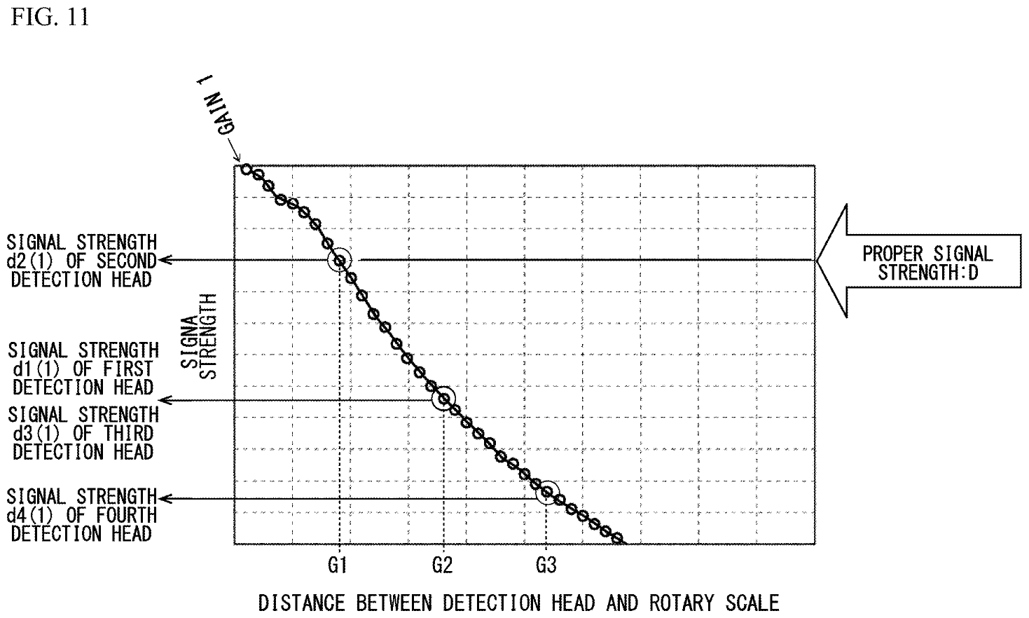

When measuring the gap of each detection head, the gain of each amplifier circuit is to the smallest gain 1. Then, the signal strength of each detection head in that state is measured. FIG. 11 illustrates the signal strength of each detection head when the gain is 1. Note that in FIG. 11, “signal strength d2(1) of the second detection head” and the like are written, but the setting gain is shown in parentheses. That is, “d2(1)” indicates the signal strength of the second detection head when the gain is 1. Other signal strengths are also shown in a similar manner. In this embodiment, since the magnitude relationship of each gap is G1<G2<G3, the obtained signal strength is d2(1)>d1(1)=d3(1)>d4(1).

Here, let D be the signal strength appropriate for detecting position data. This appropriate signal strength D is set so that flicker in position detection is minimized within the limit where the amplifier circuit and ADC are not saturated.

Setting the gain of the second detection head 5-1: The signal strength d2(1) of the second detection head 5-1 roughly matches the appropriate signal strength D. Therefore, the gain of the second detection head is determined to be “1”.

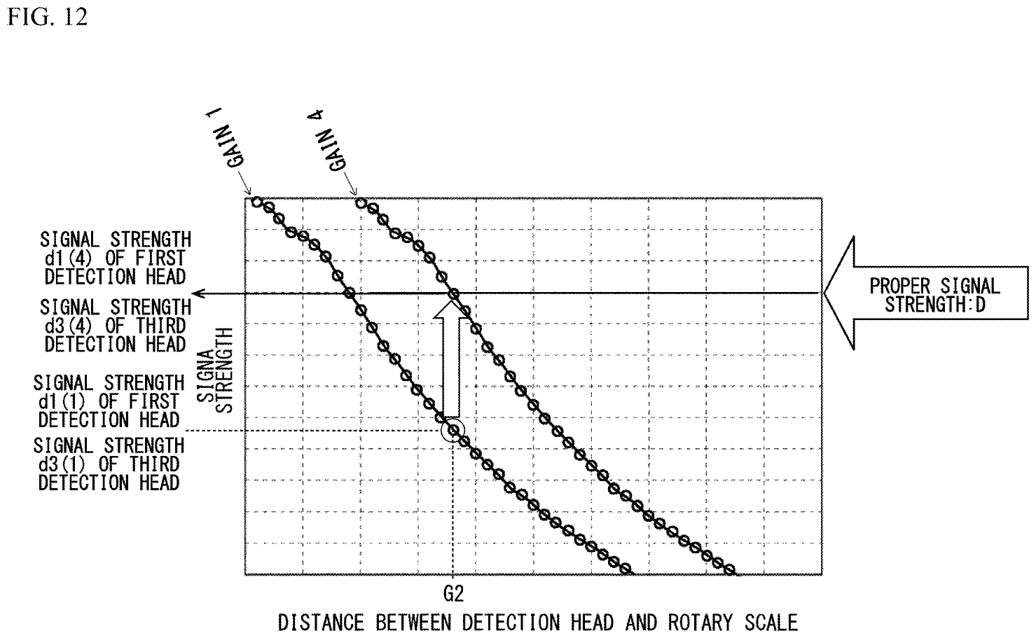

Setting the gains of the first detection head 5-0 and the third detection head 5-2: The signal strength d1(1) of the first detection head 5-0 and the signal strength d3(1) of the third detection head 5-2 are lower than the appropriate signal strength D. Therefore, the gain is increased by 1, 2, 3, and 4, and a gain that is equal to or exceeds the appropriate signal strength D is searched for. In the example illustrated in FIG. 12, at a gain of 4, the signal strengths of the first detection head 5-0 and the third detection head 5-2 are equal to the appropriate signal strength D. Therefore, the gains of the first detection head 5-0 and the third detection head 5-2 are determined to be “4”.

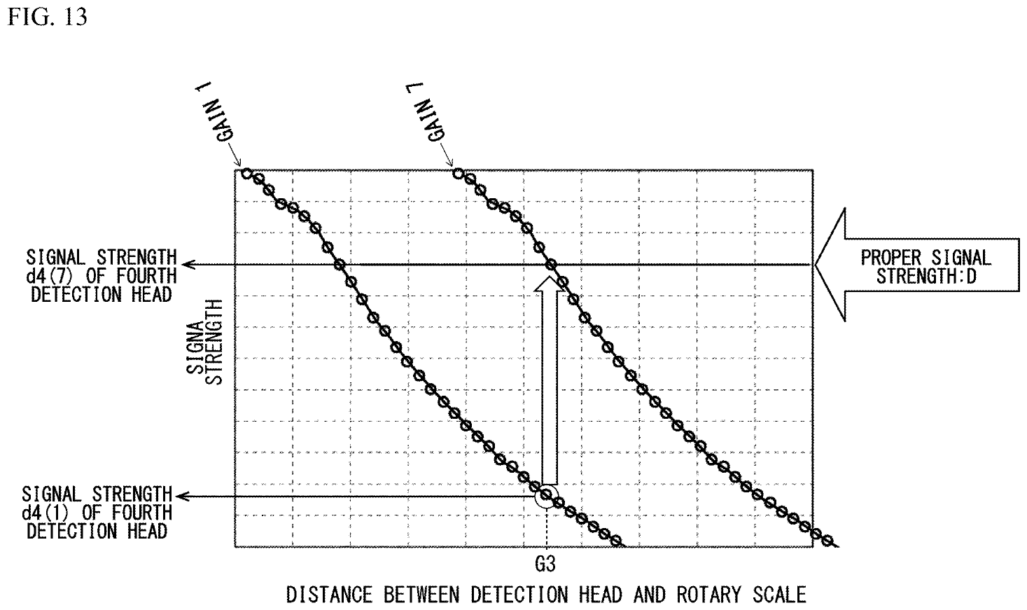

Setting the gain of the fourth detection head 5-3: The signal strength d4(1) of the fourth detection head 5-3 is also lower than the appropriate signal strength D. Therefore, the gain is increased by 1, 2, 3, and 4, and a gain that is equal to or exceeds the appropriate signal strength D is searched for. In the example illustrated in FIG. 13, at a gain of 7, the signal strength of the fourth detection head 5-3 is equal to the appropriate signal strength D. Therefore, the gain of the fourth detection head 5-3 is determined to be “7”.

In this way, by setting the gain according to the gap, more accurate detection results can be obtained.

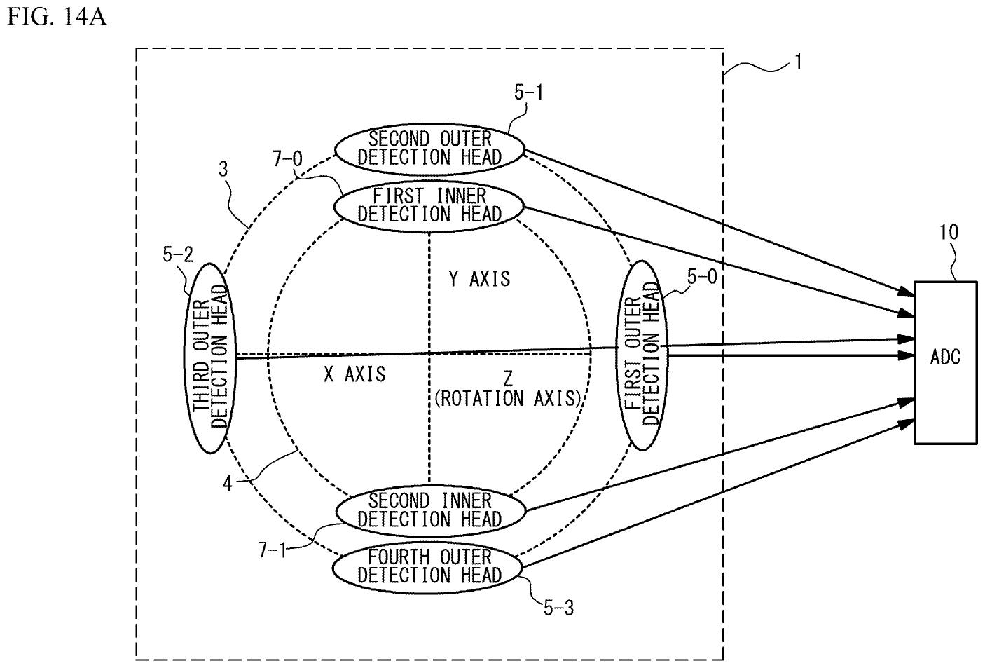

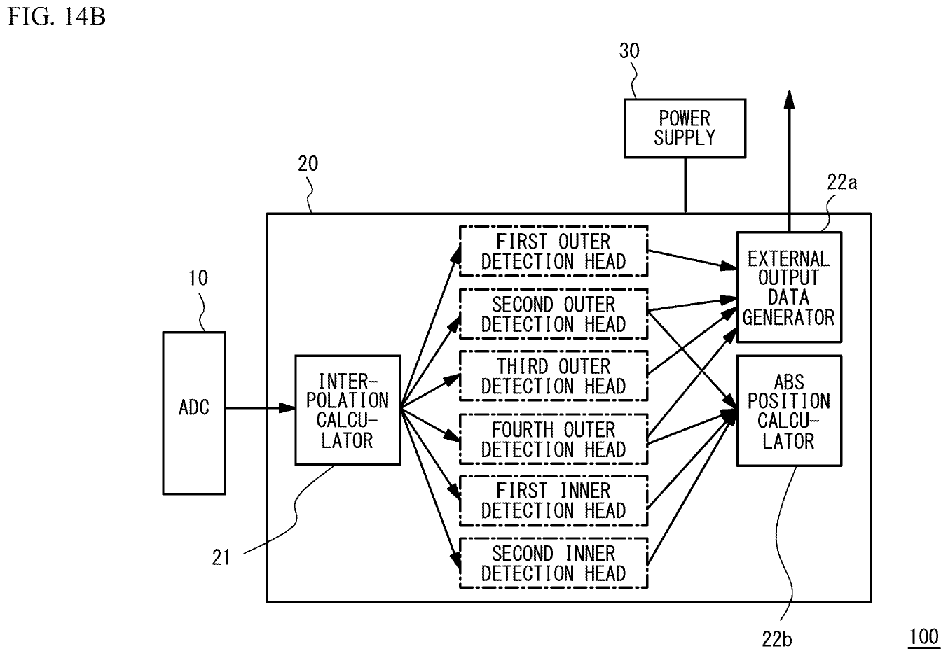

(Second embodiment) Next, a measuring device 100 of the second embodiment will be described with reference to FIG. 14A and FIG. 14B. The measuring device 100 of the second embodiment and the measuring device 50 of the first embodiment have the same hardware configuration. Therefore, common constituent elements are designated by the same reference numerals throughout the drawings, and detailed description thereof will be omitted.

The measuring device 100 of the second embodiment differs from the measuring device 50 of the first embodiment in the calculation of the absolute angle by the ABS position calculator 22b.

In the measuring device 50 of the first embodiment, the absolute angle is calculated using the angle output from six detection heads, namely, the first outer detection head 5-0 to the fourth outer detection head 5-3, the first inner detection head 7-0, and the second inner detection head 7-1. In contrast, in the measuring device 100 of the second embodiment, the absolute angle is calculated using the angle outputs from the four detection heads, namely, the second outer detection head 5-1, the fourth outer detection head 5-3, the first inner detection head 7-0, and the second inner detection head 7-1. In other words, the absolute angle is calculated based on the reading result of the outer circumference detection head and the reading result of the inner circumference detection head, which have the same circumferential position around the rotation axis. By performing such calculations, it is possible to reduce errors when calculating the absolute angle.

The measuring device 50 of the first embodiment uses four outer circumference detection heads. Therefore, errors are canceled out between the outer circumferential detection heads. Since there are two inner circumferential detection heads, errors during measurement are more likely to remain than when four detection heads are used.

On the other hand, in the measuring device 100 of the second embodiment, only two outer circumference detection heads are used to calculate the absolute angle. At this time, an outer circumferential detection head whose position in the circumferential direction around the rotation axis coincides with that of the inner circumferential detection head is selected. Therefore, even if eccentricity exists, the eccentricity error will be included in both the signal phase θ5 of the outer circumference detection head and the signal phase θ7 of the inner circumference detection head. In calculating the absolute angle, the angle output from the outer circumference detection head and the angle output from the inner circumference detection head are used. Therefore, the eccentricity error remaining in the detection by the outer circumference detection head and the eccentricity error remaining in the detection by the inner circumference detection head cancel each other out, thereby reducing the value of the absolute angle calculation error as a whole.

Note that the angle outputs from the first outer detection head 5-0 and the third outer detection head 5-2 are not used for calculating the absolute angle, but are used for calculating the external output data in the external output data generator 22a. The angle output from the first outer detection head 5-0 and the third outer detection head 5-2 together with the angle output from the second outer detection head 5-1 and the fourth outer detection head 5-3 is used for detection of the rotation angle of the object to be measured or used for detection of rotation speed.

In this way, also in this embodiment, the four outer circumference detection heads and the two inner circumference detection heads obtain angle outputs. That is, samplings are performed. However, these samplings are carried out in the following order.

That is, first, sampling (first sampling) is performed by the first outer detection head 5-0 and the third outer detection head 5-. Then, sampling (second sampling) is performed by the second outer detection head 5-1 and the fourth outer detection head 5-2. Following this, sampling (third sampling) is performed by the first inner detection head 7-0 and the second inner detection head 7-1. By performing samplings separately in this way, peak current consumption can be suppressed. Further, by performing the third sampling subsequent to the second sampling, it is possible to reduce the time lag in sampling for obtaining the angular output used for calculating the absolute angle. Thereby, the accuracy of calculating the absolute angle can be improved.

In this way, according to the second embodiment, the number of components of the measuring device 100 can be reduced, and the current consumption of the measuring device 100 can be reduced. Furthermore, the accuracy of absolute angle calculation can be improved.

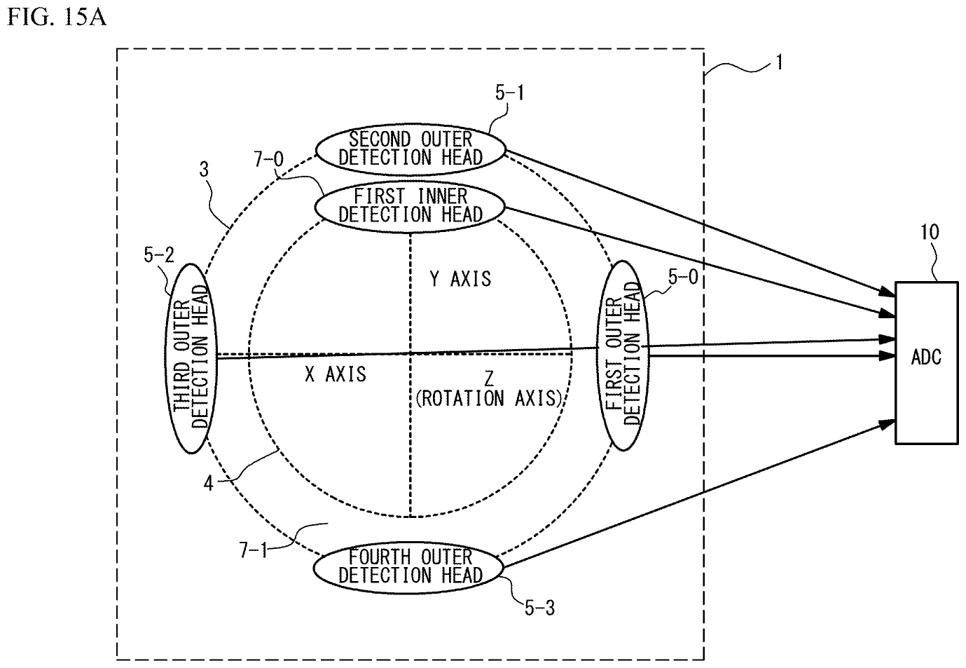

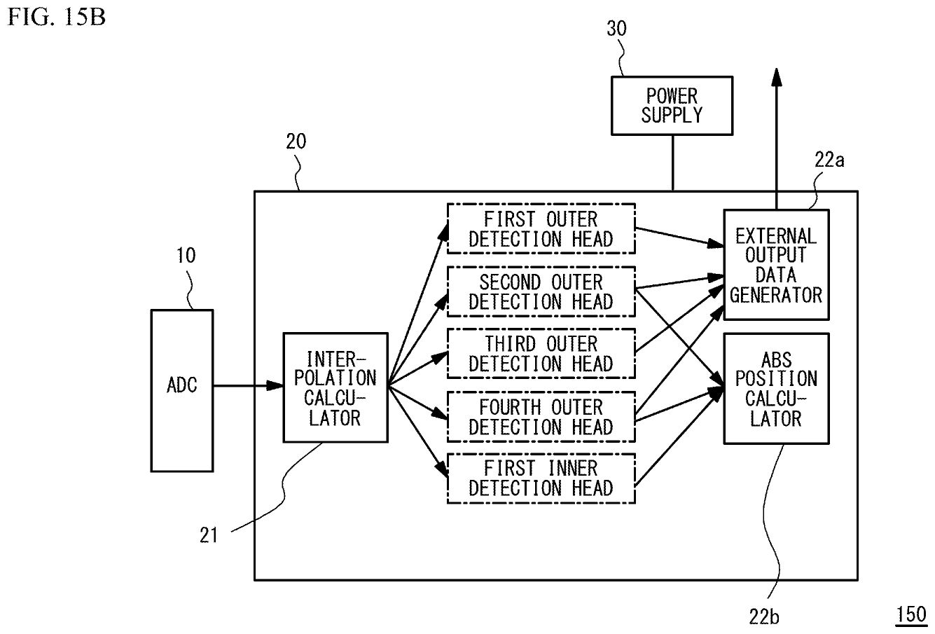

(Third embodiment) Next, referring to FIG. 15A and FIG. 15B, a measuring device 150 according to a third embodiment will be described. The measuring device 150 of the third embodiment does not include the inner second detection head 7-1 that the measuring device 50 of the first embodiment has. In other words, the measuring device 150 of the third embodiment includes only the inner first detection head 7-0 as the second pattern detection section. Other common constituent elements are designated by the same reference numerals throughout the drawings, and detailed description thereof will be omitted.

In the third embodiment, when calculating the absolute angle, the first inner detection head 7-0 and the second outer detection head 5-0 whose position in the circumferential direction coincides with the first inner detection head 7-0 are used. Therefore, similarly to the calculation of the absolute angle in the second embodiment, the eccentricity error remaining in the detection by the outer circumference detection head and the eccentricity error remaining in the detection by the inner circumference detection head cancel each other out. This reduces the absolute angle calculation error value as a whole.

In addition, as in the second embodiment, four detection heads from the first outer detection head 5-0 to the fourth outer detection head 5-3 are used to detect the rotation angle and rotation speed of the object to be measured. Therefore, the accuracy of the external output data is high. In other words, the detection accuracy of the measuring device 150 does not deteriorate.

Note that when compared with the measuring device 100 of the second embodiment, it is also possible to have a configuration in which the first inner detection head 7-0 is removed and the second inner detection head 7-1 is left. In this case, the absolute angle is calculated using the second inner detection head 7-1 and the fourth outer detection head 5-3.

Further, the hardware configuration itself may be the same as the first embodiment and the second embodiment, and the absolute angle may be calculated using one first pattern detection section and one second pattern detection section. Specifically, the absolute angle may be calculated using the first inner detection head 7-0 and the second outer detection head 5-1 whose position in the circumferential direction coincides with the first inner detection head 7-0. Further, the absolute angle may be calculated using the second inner detection head 7-1 and the fourth outer detection head 5-3 whose position in the circumferential direction coincides with that of the second inner detection head 7-1.

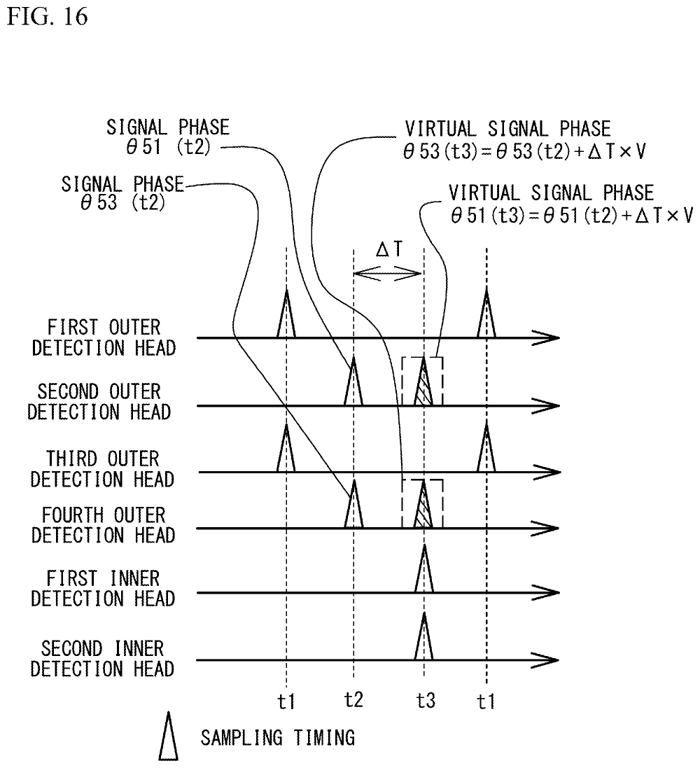

(Fourth embodiment) Next, a fourth embodiment will be described with reference to FIG. 16. The fourth embodiment employs the same hardware configuration as the first embodiment and the second embodiment. Therefore, description of the hardware configuration will be omitted here.

In the fourth embodiment, the first detection timing for signal phase detection using the first pattern detection section and the second detection timing for signal phase detection using the second pattern detection section are set to different timings. Then, based on the signal phase detected by the first pattern detection section at the first detection timing, a virtual signal phase of the first pattern detection section at the second detection timing is calculated. The absolute angle is calculated using this virtual signal phase and the signal phase detected by the second pattern detection section at the second detection timing. The virtual signal phase can be regarded as a value detected at the second detection timing. Therefore, by using the virtual signal phase together with the signal phase actually detected by the second pattern detection section at the second detection timing, the eccentricity error can be canceled out. Furthermore, errors due to detection time differences can be eliminated. Furthermore, since the actual detection timings are different, current consumption can be reduced. This makes it possible to cope with the case where many detection heads cannot be operated at the same time due to current consumption limitations.

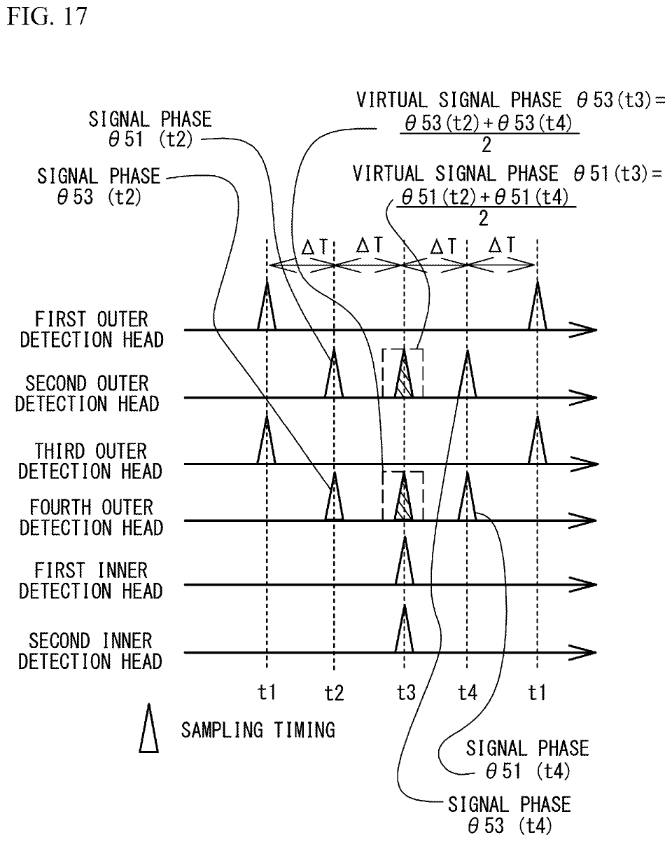

Specifically, referring to FIG. 17, the first outer detection head 5-0 and the third outer detection head 5-2 detect the signal phase at timing t1. The second outer detection head 5-1 and the fourth outer detection head 5-3 detect the phase signal at timing t2. Here, the phase signal detected by the outer second detection head 5-1 at timing t2 is expressed as θ51(t2). The phase signal detected by the outer fourth detection head 5-3 at timing t2 is expressed as θ53(t2).

The first inner detection head 7-0 and the second inner detection head 7-1 detect the signal phase at timing t3. In this embodiment, each sampling interval from timing t1 to timing t3 is ΔT.

In this way, the phase signal is detected by two detection heads at a time. Therefore, current consumption at one timing can be reduced. However, in order to offset the eccentricity error, the second outer detection head 5-1, the fourth outer detection head 5-3, the first inner detection head 7-0, and the second inner detection head 7-1 are required to detect the signal phase at the same timing.

Therefore, for the second outer detection head 5-1, the virtual signal phase θ51 (t3) at timing t3 is calculated. Regarding the outer circumferential fourth detection head 5-3, a virtual signal phase θ53 (t3) at timing t3 is calculated.

The virtual signal phase θ51 (t3) can be calculated by the following formula 4.

$$θ51 ( t 3 ) = θ 51 ( t 2 ) + Δ T \times V \qquad ( Formula 4 )$$

The virtual signal phase θ53 (t3) can be calculated by the following formula 5.

$$θ53 ( t 3 ) = θ 53 ( t 2 ) + Δ T \times V \qquad ( Formula 5 )$$

Note that ΔT is the sampling interval. V is the rotation speed of the rotary scale 2.

The virtual phase signal θ5[X−1](tn) at timing tn of the X-th outer detection head 5−[X−1] can be expressed by the following formula 6.

$$θ5 〈 X - 1 〉 ( tn ) = θ5 〈 X - 1 〉 ( tn - 1 ) + Δ T \times V \qquad ( Formula 6 )$$

Note that <X−1> is a subscript indicating the X-th detection head. Further, tn−1 indicates the sampling timing immediately before tn. Thereby, it is possible to reduce current consumption, reduce absolute angle calculation errors, and perform highly accurate measurements.

(Fifth embodiment) Next, a fifth embodiment will be described with reference to FIG. 11. The fifth embodiment employs the same hardware configuration as the first embodiment and the second embodiment. Therefore, description of the hardware configuration will be omitted here. The fifth embodiment, like the fourth embodiment, has a virtual signal phase θ51 (t3) for the second outer detection head 5-1 and a virtual signal phase θ53 (t3) for the fourth outer detection head 5-3. The fourth embodiment and the fifth embodiment differ in their calculation methods.

Specifically, referring to FIG. 11, the first outer detection head 5-0 and the third outer detection head 5-2 detect the signal phase at timing t1. The second outer detection head 5-1 and the fourth outer detection head 5-3 detect phase signals at timing t2 and timing t4. Here, the phase signal detected by the outer second detection head 5-1 at timing t2 is expressed as θ51(t2). The phase signal detected by the outer fourth detection head 5-3 at timing t2 is expressed as θ53(t2). The phase signal detected by the outer second detection head 5-1 at timing t4 is expressed as θ51(t4). The phase signal detected by the outer fourth detection head 5-3 at timing t4 is expressed as θ53(t4).

The first inner detection head 7-0 and the second inner detection head 7-1 detect the signal phase at timing t3. In this embodiment, each sampling interval from timing t1 to timing t4 is ΔT.

In this way, the phase signal is detected by two detection heads at a time. Therefore, current consumption at one time can be reduced. However, in order to offset the eccentricity error, the second outer detection head 5-1, the fourth outer detection head 5-3, the first inner detection head 7-0, and the second inner detection head 7-1 are required to detect the signal phase at the same timing.

Therefore, for the second outer detection head 5-1, the virtual signal phase θ51 (t3) at timing t3 is calculated. Regarding the outer circumferential fourth detection head 5-3, a virtual signal phase θ53 (t3) at timing t3 is calculated.

The virtual signal phase θ51 (t3) can be expressed by the following formula 7.

$$θ51 ( t 3 ) = \{ θ 51 ( t 2 ) + θ51 ( t 4 ) \} / 2 \qquad ( Formula 7 )$$

The virtual signal phase θ53 (t3) can be calculated by the following formula 8.

$$θ53 ( t 3 ) = \{ θ53 ( t 2 ) + θ53 ( t 4 ) \} / 2 \qquad ( Formula 8 )$$

The virtual phase signal θ5[X−1](tn) at timing tn of the X-th outer detection head 5−[X−1] can be expressed by the following formula 9.

$$θ 5 〈 X - 1 〉 ( tn ) = \{ θ5 〈 X - 1 〉 ( tn - 1 ) + θ5 〈 X - 1 〉 ( tn + 1 ) \} / 2 \qquad ( Formula 9 )$$

Note that <X−1> is a subscript indicating the X-th detection head. Further, tn−1 indicates the sampling timing immediately before tn. tn+1 indicates the sampling timing immediately after tn. Thereby, it is possible to reduce current consumption, reduce absolute angle calculation errors, and perform highly accurate measurements.

The present invention is not limited to the specifically disclosed embodiments or examples and variations but may include other embodiments or examples and variations without departing from the scope of the present invention.

What is claimed is:

1. A measuring device comprising:
a first scale that is provided on a rotary scale, is arranged around an rotation axis of the rotary scale, and has a plurality of first patterns arranged along a circumferential direction of the rotary scale;
a second scale that is provided on the rotary scale, is arranged around the rotation axis, has a plurality of second patterns arranged along the circumferential direction and located at different positions from the first scale;
a plurality of first pattern detection sections that are arranged around the rotation axis, each of which faces the first scales and reads at least a part of the plurality of first patterns;
a second detection section that faces the second scale and reads at least a part of the plurality of second patterns; and
a calculator configured to identify an absolute angle of the rotary scale, on a basis of a reading result of the plurality of first pattern detection sections and a reading result of the second pattern detection section,
wherein a number of the second pattern detection section is less than a number of the plurality of first pattern detection sections.

2. The measuring device as claimed in claim 1, wherein a circumferential position of the second pattern detection section with respect to the rotation axis coincides with any one of circumferential positions of the plurality of first pattern detection sections with respect to the rotation axis.

3. The measuring device as claimed in claim 1, wherein the calculator is configured to identify the absolute angle of the rotary scale on a basis of a reading result of one of the plurality of first pattern detection sections of which the circumferential position around the rotation axis coincides with the circumferential position of the second pattern detection section around the rotation axis, and a reading result of the second pattern detection section.

4. The measuring device as claimed in claim 1, wherein a number of the plurality of first patterns is different from a number of the plurality of second patterns.

5. The measuring device as claimed in claim 1,
wherein the calculator calculates a virtual reading result of the plurality of first pattern detection sections at a first timing at which the second pattern detection section performs a reading, on a basis of the reading result of the plurality of first pattern detection sections at a second timing different from the first timing, and identifies the absolute angle of the rotary scale on a basis of the reading result of the second pattern detection section at the first timing and the virtual reading result.

6. The measuring device as claimed in claim 5, as the virtual reading result, the calculator uses a value obtained by adding a value obtained by multiplying a sampling interval ΔT by a rotation speed V of the rotary scale to the reading result of the plurality of first pattern detection sections at the second timing, which is set at a time earlier than the first timing by the sampling interval ΔT.

7. The measuring device as claimed in claim 5,
wherein, the calculator calculates an average value between the readier result of the plurality of first pattern sections at the second timing, which is set at a time earlier than the first timing, and the reading result of the plurality of first pattern detection sections at a third timing, which is set at time later than the first timing, and uses the average value as the virtual reading result.

8. The measuring device as claimed in claim 1, wherein each of the plurality of first pattern sections has a gain according to a gap between each of the plurality of first pattern detection sections and each of the plurality of first patterns.

9. An absolute angle identification method for identifying the absolute angle in the measuring device claimed in claim 1,
the method comprising:
reading the plurality of first patterns by using the plurality of first pattern detection sections;
reading the plurality of second patterns by using the second pattern detection section; and
calculating an absolute angle of the rotary scale on a basis of a reading result of the plurality of first pattern detection sections and a reading result of the second pattern detection section.
